(19) United States
(12) Patent Application Publication
(10) Pub. No.: US 2013/0132112 A1
(43) Pub. Date: May 23, 2013

(54) SYSTEMS AND METHODS FOR CLINICAL PROTOCOL DEVELOPMENT

(71) Applicant: TRANSPARENCY LIFE SCIENCE, LLC., New York, NY (US)

(72) Inventors: Tomasz Sablinski, Short Hills, NJ (US); Marc Foster, Brookline, MA (US); Martin Streeter, Newton, MA (US); Gareth Hicks, Caldwell, NJ (US); Lawrence Steinman, Stanford, CA (US)

(73) Assignee: TRANSPARENCY LIFE SCIENCE, LLC., New York, NY (US)

(21) Appl. No.: 13/679,242

(22) Filed: Nov. 16, 2012

Related U.S. Application Data
(60) Provisional application No. 61/561,445, filed on Nov. 18, 2011.

(51) Int. Cl. G06Q 50/22

(52) U.S. Cl. 705/2

(57) ABSTRACT

Various aspects relate to the development of clinical study (a.k.a. trial) protocols in drug development. Is some settings, the trial development process can be optimized by integrating and receiving feedback from a large number of participants (physicians, researchers, technicians, drug developers, patients, etc.). Some embodiments invoke the combined wisdom of the user population by targeting relevant audiences for feedback and input into clinical study protocol development. User input can be solicited and developed in an open format, allowing the system capture the largest knowledge base regarding protocol development. In some settings, a set of “protocol challenges” are presented by a protocol builder system to a global community of drug developers, scientists, physicians, and patients to develop and identify issues with a clinical study protocol. Protocol challenges can be used to identify the best set of criteria for a given clinical study protocol.

### BACKGROUND

Drug protocol development is an area that can be surrounded in complex and difficult to understand procedures. Conventional approaches to drug protocol development are typically controlled entirely by drug developer insiders, who can oftentimes be reluctant to share techniques for development and administration of their trials.

In some conventional approaches, drug developer insiders can identify a therapeutic need and a potential drug to resolve that need. The drug developer insiders collect any historic drug protocol trials that may be applicable and rely on their own experience and knowledge to identify the protocol details that will be required for human trials. A candidate protocol is reviewed by an expert panel to identify additional criteria that may be appropriate or to identify issues with the existing criteria for the protocol. The protocol can be revised and optionally reviewed and revised multiple times. Once review and revision is complete, the final trial protocol can be proposed for execution. Various administrative bodies oversee approval of these drug protocols. Requirements for approval can be vigorous, especial where a proposed trial is seeking human phase testing. If approved, the trial protocol can then enter testing. In some settings, issues associated with such protocols are revealed only during test execution, thereby increasing time and cost, without providing a degree of certainty that all potential issues have been identified.

### SUMMARY

In broad overview various aspects relate to the development of clinical study (a.k.a. trial) protocols in drug development. In some settings, the trial development process can be optimized by integrating and receiving feedback from a large number of participants (physicians, researchers, technicians, drug developers, patients, etc.). Some embodiments invoke the combined wisdom of the user population by targeting relevant audiences for feedback and input into clinical study protocol development. User input can be solicited and developed in an open format, allowing the system to capture the largest possible knowledge base regarding protocol development.

In some settings, a set of “protocol challenges” are presented by a protocol builder system to a global community of drug developers, scientists, physicians, and patients to develop and identify issues with a clinical study protocol. A clinical study protocol represents the collection of all aspects of a specific scientific experiment, which is part of a broader development path for a new drug or therapy. The scientific experiment can define patient population by inclusion characteristics (e.g., males age 50+), a drug to administer, including dosage, timed release or not, a placebo to administer to subjects in a control group, size of the study population, exclusion criteria (e.g., no existing heart conditions). Protocol challenges can be used to identify the best set of criteria for a given clinical study protocol (“protocol”).

The system can be configured to ask participating individuals to respond to questions identified with the protocol challenges. Each challenge can be composed of individual or groups of questions. In some embodiments, the questions include both multiple choice and open-response interfaces for accepting answers. In one embodiment, the system provides for protocol challenges based on drug candidates in specific indications by posing challenge questions directly pertaining to key clinical study parameters: including research methods, study population, statistical analysis, study design, study procedures, and potential adverse events.

In one aspect, the system includes a curated environment implemented over a public network (e.g., the Internet) for rapid design of scientific experiments within or encompassing a clinical study. The curated environment includes, for example, a research or patient advocate assigned to review and/or approve postings and submissions within the environment. In some embodiments, the research or patient advocate can act as the curator in the curated environment. As the scientific experiments being developed can include human trials, the research or patient advocate can review any suggested experiment for safety, impact, quality, deviation from conventional medical approach, and effect on study participants of the scientific experiment being developed among other options.

Some scientific experiments are constructed for testing unproven clinical treatments in humans. In one example, the curated environment solicits user input through interactive surveys. Some embodiments employ the feedback delivered by the interactive surveys to optimize the development of a clinical study protocol. In one example, the curated environment allows for significant reduction in development time over some conventional trial development methodologies. User surveys can be targeted to a particular user population and the resulting information collected to allow the system to quickly evaluate and enhance, for example, a drug development plan or a therapeutic approach. In some embodiments, the system is configured to provide for evaluation of user submissions for compensation. According to one embodiment, an evaluation process is described that provides fair, equitable, and timely rewards to users free of any bias. Unbiased and fair compensation serves the system by encouraging participants to submit their ideas. Unbiased and fair compensation can also serve the system by encouraging continued participation.

In some embodiments, the highest scoring submissions can be identified from submissions of a large number of registered participants. The large number of participants can include invited participants, whereas in some conventional protocol development processes, only a small number of participants provide their opinion on any given protocol. In some conventional approaches, the limited number of participants often requires additional time to develop adequate protocols for human phase trials. Some conventional approaches also require expert review of any given protocol and multiple reformulations of the protocol during development and even during the execution of a trial. Other conventional approaches limit the development process to the same participants, and fail to open development to a broader community.

According to some aspects, identification of known issues based on previous trials and the collective experience of the users becomes readily available during protocol development as a result of the curated environment. This open design approach can take advantage of the wisdom of the crowd by opening the protocol development process to a broad community. In some embodiments, the curated environment includes open development models, where protocol development questions are presented and results shared to facilitate protocol development. As a result, the protocols are developed faster and with a greater degree of certainty. In the curated environment, the development process insures that the appropriate questions have been identified, known issues have been explored, and the various inclusion/exclusion criteria for a given protocol have been evaluated to reduce any mistakes and/or changes in the protocol after a trial begins.

In some aspects, clinical study protocol development projects are curated by a scientific or patient review advocate. The scientific or patient review advocate interactively monitors the curated environment and publishes a partial list of scientific or patient-focused procedural issues/questions within the curated environment in a post related to a given clinical project for users to submit opinions and/or feedback. The problem(s) for which solutions are sought are referred to as protocol challenges. Each clinical study protocol can be organized based on subject matter, area of expertise (e.g., cardiology, neurology, infectious disease, etc.) of the protocol. A plurality of clinical study protocols can be designated by title within any subject matter category. The titles of each protocol can be reflective of the subject matter and provide additional description of the respective clinical study protocol. The environment can also be configured to provide access to protocol challenges based on the nature of the challenge for which a solution and/or participation is requested.

Compensation for submissions is determined based on an evaluation of the submissions received for a clinical study protocol. Review criteria are typically published with the protocol challenge. Acceptance of terms and the review criteria can be required prior to participation. In some embodiments, the research or patient advocates determine how well a submission meets the challenge and/or challenge requirements. In some implementations, research or patient advocates consider each of a set of review criteria, as discussed further herein, in the determination of scientific and technical merit, and give a separate score for each of the criteria for any submission provided by a user.

In some embodiments, the definition of a clinical study protocol includes a challenge to the participants to resolve issues associated with a drug protocol or provide information for improving a specific drug protocol. A given challenge can include review criteria for scoring any submission. A user submission does not need to be strong in all categories in any set of review criteria to be judged likely to have affected a success of a downstream clinical development project and earn awards. For example, a given development project may by its nature involve challenges with solutions that are not innovative. “Noninnovative” solutions may be essential to advance a clinical development project and thus earn compensation regardless of their novelty.

The protocol builder system can be configured to assign a research or patient advocate to each protocol challenge. The research or patient advocate evaluates each user submission. In some settings, each submission receives a score for each one of a set of review criteria, with submissions having higher scores earning compensation. In some embodiments, a research or patient advocate manually scores the submissions. In some embodiments, the research or patient advocate can employ discretion in weighing different criteria differently in developing an overall score for a given submission. Other embodiments can include evaluation components, which automatically review submissions for required criteria. Evaluation components can also be configured to provide suggested scores for review by a research or patient advocate. In some examples, natural language processing can be implemented on the evaluation components to identify a minimum level of compliance with the review criteria. In some other embodiments, the evaluation components can also be configured with learning algorithms to determine suggestions for scoring a given review criteria and/or generating an overall score for a submission. Once scoring is resolved, compensation can be determined according to any rules published for the protocol challenge.

According to another aspect, the system provides for peer review of user submissions. In some embodiments, peer review can influence protocol development, challenge selection, and/or quality evaluations associated with any user submission. In further embodiments, peer review can be used to determine compensation for participants, and in others, can be used as a factor in any compensation determination.

According to one aspect, a system for open clinical study protocol development is provided. The system comprises at least one processor operatively connected to a memory, the at least one processor when executing provides a user interface configured to register a plurality of users for access to a curated environment, wherein the user interface is further configured to provide access to protocol development projects, a challenge generation component configured to identify candidate challenges for protocol development, wherein each candidate challenge is configured to define at least one aspect of a clinical trial for a drug, an evaluation component configured to present candidate challenges for acceptance, wherein the evaluation component is further configured to receive approval for at least some of the candidate challenges, wherein the user interface is further configured to accept a plurality of submissions from a plurality of registered users in response to the approved challenges, and wherein the evaluation component is further configured to present the plurality of submissions for review by a review advocate.

According to one embodiment, the system further comprises matching component configured to match information in a protocol development project against existing clinical protocol approaches. According to one embodiment, the challenge generation component is configured to identify at least one candidate challenge for protocol development, responsive to the match by the matching component. According to one embodiment, the system further comprises a matching component is further configured to match a research or patient advocate to a protocol development project. According to one embodiment, the evaluation component is configured to present the candidate challenges to the research or patient advocate for approval. According to one embodiment, the evaluation component is further configured to receive scores for each of the plurality of submission from the research or patient advocate.

According to one embodiment, the system further comprises a communication component configured to deliver the plurality of submissions to each one of the plurality of registered users who submitted a response. According to one embodiment, the communication component is configured to provide access to protocol development projects and the plurality of submissions to any registered user. According to one embodiment, the communication component is configured to query publically available information on known protocol development approaches and define a template library of information associated with the known protocol development approaches. According to one embodiment, the evaluation component is configured to determine procedural and safety issues for at least one protocol development project. According to one embodiment, the evaluation component is configured to generate verifiable targets for inclusion in at least one protocol development project.

According to one embodiment, the challenge generation component is configured to define survey questions for at least one candidate challenge that define the at least one aspect of the clinical trial for the drug. According to one embodiment, the challenge generation component is configured to tailor survey questions to target at least one of: ideas from related publications, examples from similar projects, previously executed studies, and study population characteristics.

According to one aspect, a computer implemented method for clinical study protocol development is provided. The method comprises providing access to a user interface accessible over a communication network, displaying in the user interface a plurality of protocol development projects, accepting, by a computer system, a plurality of user submissions responsive to displayed challenges representing certain design elements associated with the protocol development projects, accepting, by the computer system, evaluations of the plurality of user submissions determined by a research or patient advocate, and establishing, by the computer system, at least one element of a clinical study protocol based on the evaluations of the plurality of user submissions.

According to one embodiment, the method further comprises an act of presenting the evaluations of the plurality of user submissions to a plurality of users, wherein the plurality of users input respective submissions for a respective protocol development project. According to one embodiment, the method further comprises an act of identifying, by the computer system, candidate challenges for protocol development, wherein each candidate challenge is configured to define at least one aspect of a clinical trial for a drug. According to one embodiment, the act of identifying includes an act of generating, by the computer system, at least one candidate challenge for protocol development, in response to matching at least one of the plurality of protocol development projects to an existing clinical protocol.

According to one embodiment, the method further comprises an act of presenting in a user interface candidate challenges for acceptance. According to one embodiment, the method further comprises an act of identifying potential users based on matches determined between information associated with a protocol development project and demographic information of the potential users. According to one embodiment, the method further comprises an act of inviting the potential users to participate in the protocol development project. According to one embodiment, the method further comprises an act of displaying the plurality of user submissions to registered users. According to one embodiment, the method further comprises an act of querying publically available information on known protocol development to define a template library of information associated with the known protocol development approaches. According to one embodiment, the method further comprises an act of determining, by the computer system, procedural and safety issues for at least one protocol development project.

According to one embodiment, the method further comprises an act of generating, by the computer system, verifiable targets for inclusion in the at least one protocol development project. According to one embodiment, the method further comprises an act of generating, by the computer system, survey questions for at least one of the displayed challenges, wherein the response are configured to define the at least one element of a clinical study protocol. According to one embodiment, the act of generating includes tailoring survey questions to target at least one of: ideas from related publications, examples from similar projects, previously executed studies, and study population characteristics. According to one embodiment, the plurality of user submissions include at least one of protocol challenges and responsive submissions.

According to another aspect, provided is a computer-readable medium having computer-readable signals stored thereon that define instructions that, as a result of being executed by a computer, instruct the computer to perform the method for clinical study protocol development. Various embodiments of the computer-readable medium implement the individual method steps above and their combination.

Still other aspects, embodiments, and advantages of these exemplary aspects and embodiments, are discussed in detail below. Any embodiment disclosed herein may be combined with any other embodiment in any manner consistent with at least one of the objects, aims, and needs disclosed herein, and references to “an embodiment,” “some embodiments,” “an alternate embodiment,” “various embodiments,” “one embodiment” or the like are not necessarily mutually exclusive and are intended to indicate that a particular feature, structure, or characteristic described in connection with the embodiment may be included in at least one embodiment. The appearances of such terms herein are not necessarily all referring to the same embodiment. The accompanying drawings are included to provide illustration and a further understanding of the various aspects and embodiments, and are incorporated in and constitute a part of this specification. The drawings, together with the remainder of the specification, serve to explain principles and operations of the described and claimed aspects and embodiments.

### BRIEF DESCRIPTION OF THE DRAWINGS

Various aspects of at least one embodiment are discussed below with reference to the accompanying figures, which are not intended to be drawn to scale. Where technical features in the figures, detailed description or any claim are followed by reference signs, the reference signs have been included for the sole purpose of increasing the intelligibility of the figures, detailed description, and claims. Accordingly, neither the reference signs nor their absence are intended to have any limiting effect on the scope of any claim elements. In the figures, each identical or nearly identical component that is illustrated in various figures is represented by a like numeral. For purposes of clarity, not every component may be labeled in every figure. The figures are provided for the purposes of illustration and explanation and are not intended as a definition of the limits of the invention. In the figures:

FIG. 1 illustrates an example approach to drug protocol development;

FIG. 2 is an example process for requesting development of a clinical study protocol, according to one embodiment;

FIG. 3 is an example process flow for receiving and evaluating user submissions, according to one embodiment;

FIG. 4. illustrates an example block diagram of milestones for the development of a clinical study protocol, according to one embodiment;

FIG. 5 is an example a block diagram of an example protocol builder system, according to one embodiment;

FIG. 6 is an example of a screen capture of an example user interface, according to one embodiment;

FIG. 7 is an example registration screen of a user interface, according to one embodiment;

FIG. 8 is a screen capture of an example protocol development project detail screen, according to one embodiment;

FIG. 9 is a screen capture of an example challenge screen, according to one embodiment;

FIG. 10 illustrates a screen capture of user interface showing challenge questions, according to one embodiment;

FIG. 11 is a block diagram of one example of a computer system that may be used to perform processes and functions disclosed herein;

FIG. 12 is a block diagram of one example of a computer system that may be used to perform processes and functions disclosed herein;

FIG. 13 illustrates an example process for approving challenges for protocol development, according to one embodiment;

FIG. 14 illustrates an example process for matching protocol projects, according to one embodiment; and

FIG. 15 illustrates an example process for matching protocol information, according to one embodiment.

### DETAILED DESCRIPTION

One embodiment of a protocol builder system provides for interactive protocol design and analysis. The system provides users with a controlled, curated environment for clinical study protocol synthesis, formal analysis, and offers both software and hardware components configured for protocol assessment and optimization. The system assists the user in the documentation of clinical study protocol designs by autonomously extracting protocol templates based on analysis of the clinical study protocol submitted to the system. The system can be further configured for the generation of protocol implementations from abstract specifications that can be executed as part of a trial. The system can also be configured to prompt participants (e.g., researchers) to widen the scope of clinical study protocol reviews, opening project development to a broad community. The system can also be configured to permit all stakeholders in the project visibility into, and overall confidence in, the development of an on-going scientific project. In some implementations, the system provides for transparent development from multiple perspectives, including, for example, open development by a broad community, and also, provides visibility for stakeholders interested in the protocol development.

It is realized that when writing a clinical study protocol the scientist or the patient affected by disease to be researched in any given scientific experiment initially strives to clarify the reason behind the science, in other words, the structure and operational aspects of the project. According to some aspects, it is recognized that no one individual (or even one drug development group) has complete knowledge of every drug trial. The protocol builder system prompts stakeholders (e.g., researchers, physicians, patients, drug developers, etc.) for timely input on pivotal project challenges. According to some embodiments, decisions based upon research methods, clinical study population, statistical analysis, clinical study design, clinical study procedures, and potential adverse events are examined and cleared by a large population of users. As these decisions influence all of the downstream clinical trial costs and project completion dates, the protocol builder system reduces complexity, costs, and risks associated with developing and implementing clinical study protocols. In some examples, the protocol builder system can be configured specifically to facilitate drug protocol development.

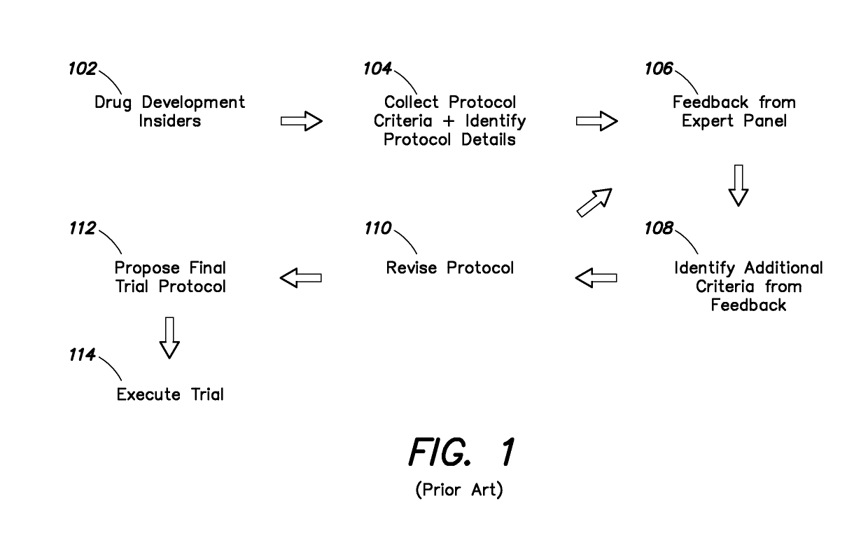

Various aspects of the system can be better appreciated with respect to an understanding of some conventional approaches to protocol development shown in FIG. 1. Illustrated in FIG. 1 is an example of conventional approaches to drug protocol development. In some conventional approaches, drug developer insiders can identify a therapeutic need and a potential drug to resolve that need at 102. The drug developer insiders collect any historic drug protocol trials that may be applicable and rely on their own experience and knowledge to identify the protocol details that will be required for human trials at 104. At 106, the protocol is reviewed by an expert panel to identify additional criteria that may be appropriate at 108 or to identify issues with the existing criteria for the protocol. The protocol can be revised at 110 and optionally reviewed and revised at 106-110. Once review and revision is complete, the final trial protocol can be proposed at 112. Various administrative bodies oversee approval of drug protocols. Requirements for approval can be stringent, especially when a proposed trial involves human subjects. If approved, the trial protocol can enter testing at 114. In some setting, issues associated with the protocol are revealed during test execution, increasing time and cost, without providing a degree of certainty that potential issues have been identified.

It is realized that drug developers and expert reviewers involved in the traditional closed approach to protocol design represent only a small portion of the population of knowledgeable persons available worldwide. When writing a clinical study protocol these scientists initially strive to clarify the rationale behind the science related to the drug development project. These scientists attempt to describe the structure and operational aspects of the project. Unfortunately, no one individual has complete knowledge of previously used clinical study protocols, thus approaches that rely on the input of small groups are often incomplete and therefore flawed.

It is also realized that considerable time and money can be saved by improving the design and review of conventional clinical study protocols. Decisions based upon research methods, clinical study populations, statistical analysis, clinical study design, clinical study procedures, and potential adverse events all can contribute to the overall cost and time it takes to complete a clinical research project. Cost factors influence a project's speed (including cycle time, planning time, timely patient enrollment), quality (including capturing data at its source, reduced error rates, automatic audit trials), and collaboration (creating a positive experience for patients, clinical investigators, study coordinators, and a sponsor's staff). By inviting the participation of a larger community of researchers, physicians, experts, patients, etc., the drug development process can be significantly improved.

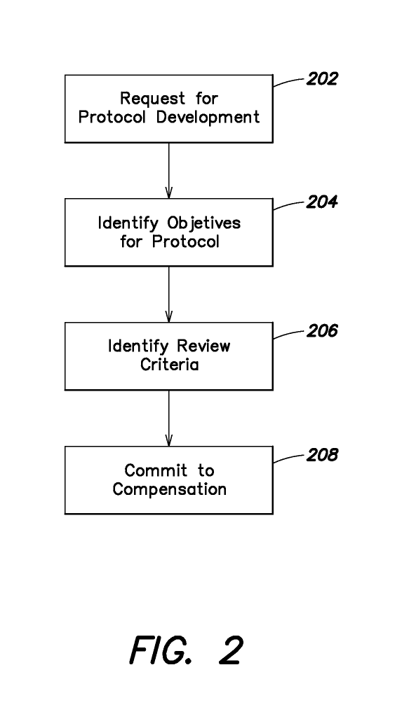

Shown in FIG. 2 is an example of process flow for facilitating development of a clinical study protocol. At 202, a user prepares a request for protocol development including an overview of the protocol that will be displayed on the protocol builder system and submits the request within a user interface of the system. The requesting user can be prompted by the system to include any known objective(s) for the protocol at 204. The requestor and/or the system can identify the review criteria that will be used to evaluate responsive submissions at 206. In some embodiments, the requesting users provides their own detailed criteria. In some embodiments, the system is configured to suggest evaluation criteria that the requesting users can approve or deny. The system can also be configured to match a protocol development request to existing requests on the system, and suggest review criteria based on the matches. As part of the request for protocol development, the requesting user can commit at 208 to providing compensation to users answering the request for protocol development. The system can be configured to suggest ranges of compensation based on other protocol requests. Once the request for protocol development is complete the request can be published by the system for review by other users.

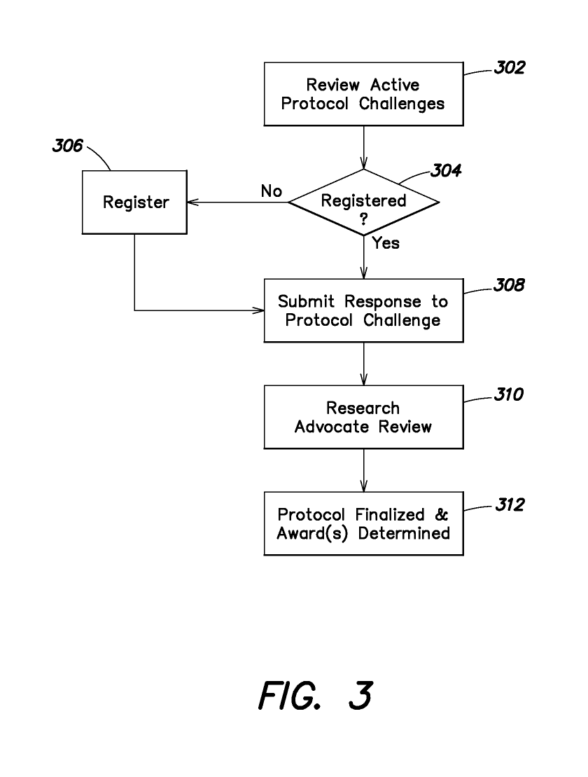

FIG. 3 illustrates an example process flow for receiving and evaluating user submissions, which can be executed by the protocol builder system. At 302, a user can review protocol challenges in a user interface of the system. Typically, the user can access the interface over the internet via a connected host computer system. Not shown, the user can access inactive protocol challenges as well as active challenges. However, in some embodiments the system is configured to only permit submission for active challenges.

Once the user has found a protocol challenge on which the user wishes to participate, the user can indicate in the user interface that he wishes to submit a response. At 304 the system determines if the user is registered. The system can request authentication information or the system can determine that the user is already registered and authenticated at 304 YES and proceed to 308. If the user is not registered 304 NO, the system is configured to request that the user register prior to submitting a response to any challenge. Registration can include additional processes executed by the system. In some embodiments, the system requests identifying information in the user interface, and further requires the user to agree to the terms of the protocol challenge and can also require the user agree to the any terms of use. Registered users can submit their respective response to the protocol challenge at 308.

The response can involve a response to part of or the entire challenge, including best approaches for research, analysis, experimental procedure, study population, inclusion and/or exclusion criteria, for example. In some embodiments, responding users are asked questions through the user interface on the protocol challenges. In some embodiments, the questions include both multiple choice and open-response formats.

In some embodiments, user submissions can be published with the protocol challenge as they are received, and users can submit comments or responses directed to other users' submissions. In other embodiments, only the protocol challenge information is published by the system, keeping responses private. In some embodiments, At 310, a research or patient advocate reviews user submissions. Review can occur during the active period of the protocol challenge. In some embodiments, the questions asked of participating users can evolve based on prior user responses. The research advocated can manage changes to the questions delivered to the participating users during the course of protocol challenge based on the review of prior submissions.

In some embodiments, the review at 310 can be repeated for each user submission, and in some embodiments at 310 can occur after the expiration of any deadline associated with the protocol development request. Review can include scoring of each response against the review criteria provided with the protocol development request. The research or patient advocate can finalize a proposed protocol in response to the review at 312. Further, the research or patient advocate can be responsible for determining awards to the participating users based on the review criteria and/or scoring assigned to each submission. In some embodiments, the research or patient advocate submits scores for each one of a set of review criteria and the system is configured to determine an award based on the scoring.

In further embodiments, review processing can also include evaluation of user comments on other user submissions. In some examples, quality metrics can be assigned to a user submission based on feedback provided by other users. In one example, a user can be presented with an option to approve another user's submission (including e.g., a challenge response). Based on a number of approvals for a given submission, a quality value can be assigned. Quality values can also modified based on disapproval received from peers.

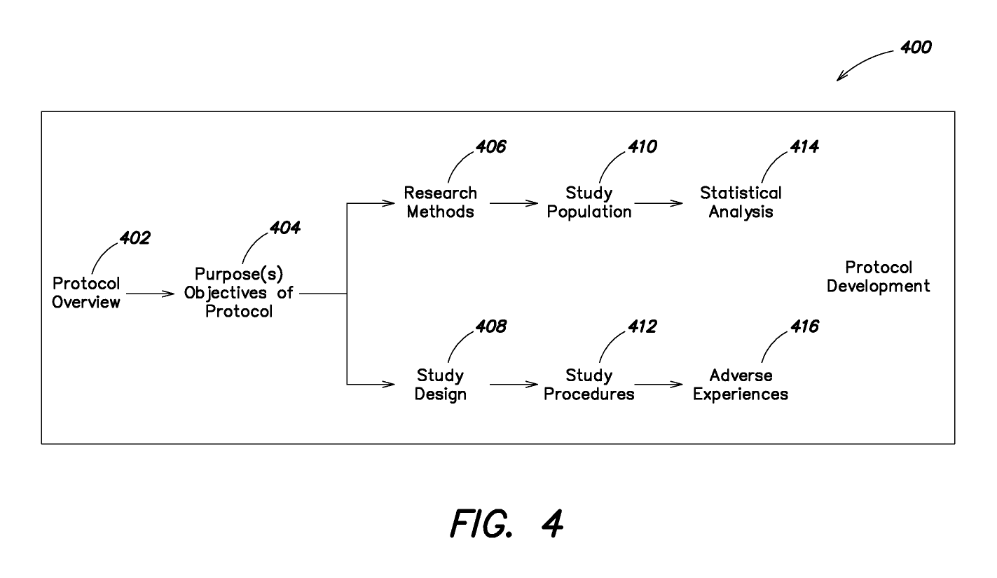

The processes illustrated in FIGS. 2 and 3 can be executed together by the protocol builder system as part of an overall flow for developing a clinical study protocol. FIG. 4 illustrates an example block diagram of milestones for the development of a clinical study protocol. According to one embodiment, the protocol builder system is configured to generate a protocol overview from user submissions to the respective questions at 402. The protocol overview is used to further define purpose(s)/objective(s) of the protocol at 404. Protocol development 400 and definition can proceed along two branches as submissions responding to protocol development request are received from other users of the system. The questions and thus the responsive submissions can be targeted to elicit responses on research methods and/or study design. The protocol builder system can be configured to identify qualifying information for a participating user based on registration information, including areas of expertise, drug development history, research activity, areas of specialization, medical practice areas, etc.

Review of the respective submission can determine group opinion on research methods 406 for the protocol and any group opinion on the study design 408 parameters. Further questions can be presented by the system to arrive at the group opinion on study population at 410. Each response to the study population questions can be evaluated and/or scored to arrive at the group opinion. Development of study procedures 412, statistical analysis 414, and adverse experiences 416 can all be examined by as large of a user population as possible. Insuring the largest participating population, while providing for independent review by a research or patient advocate yields a protocol with a high level of confidence that the best process and potential issues have been identified. Additionally, providing responses to the participating community in an open format further fosters the development process by increasing the knowledge base and accelerating identification of issues within the environment. In some embodiments, the research or patient advocate can take an active role revising challenge questions as responses from the participating community are received. Received comments can also prompt the research or patient advocate to review and/or revise challenge questions in response to group opinion.

Each of the milestones illustrated in FIG. 4 can include multiple components depending on the protocol being developed and any criteria generated by a user requesting protocol development. In some embodiments, a clinical protocol overview can be generated from ideas from colleagues, experts, and world-class thought leaders. In some examples, questions on a protocol challenge are designed to elicit ideas from related published articles, and can also be designed to obtain examples from analogous projects. Development of the purposes and/or objects for any given protocol are discovered from the user population, and can also be identified from review of analogous projects, historic studies, and in some examples, can be intellectual property (confidential or otherwise) of the requesting user.

In establishing research methods, the protocol builder system is configured to generate a process for carrying out any scientific experiment associated with the clinical study protocol. In some embodiments, a duration, and criteria for measuring results will be established or improved through user submission of responses. In some examples, responses to user questions can be used to establish both dependent variables and independent variables for a protocol. A scientific experiment for validating a new drug or protocol can include, for example, a hypothesis statement or declaration of the expected outcome of the research study. The statement can be based on logical rationale and is generated so that the statement results in empirical possibilities for testing. The system can be configured to generate such a hypothesis, and can be further configured to identify testable targets during and at the completion of the experiment.

In some embodiments, the hypothesis statement can include any one or more of: (1) dependent and independent variables; (2) some type of relationship between independent and dependent variable; (3) a change in the independent variable and any effect on the dependent variable, and (4) the subjects, i.e. population being studied. For a given experiment, the independent and dependent variable define a relationship, in which one variable depends on the other variable. In the clinical study setting, a typical example can include high blood pressure and cardiovascular risk. Other independent variables and dependent variables can be identified for a study population, a treatment, a new drug, etc.

According to some embodiments, the protocol builder system is configured to provide for study population review and evaluation. The system can be configured to review and evaluate any patient recruitment plan for the clinical study which directly effects the study population that will be available for testing. In some settings the patient recruitment plan can be determined based on user responses. In some examples, implementation details for the protocol can also be reviewed, evaluated, and/or generated for inclusion in the protocol. In some embodiments, the system can review, evaluate, and/or generate: subject retention processes; estimates on the number of sites; estimates on the number of subjects required for the clinical study; among other study population parameters. The system is configured to identify and flag any procedural or safety issues that can limit feasibility. In human phase trial identification of safety risk can be tantamount to earning approval to conduct testing.

The protocol builder system can be further configured to establish guidelines for statistical analysis. In some examples, primary statistical analysis can be modeled on previous studies. The overall statistical methods can be selected by the system, and/or confirmed by the user population. The statistical methods can be then employed along with the determination of both the dependent and independent analysis variables identified as part of the research methods. Examples of establishing dependent and independent variables can include establishing measureable baseline and treatment characteristics to be used in the study. Other variables can be defined by the system to cover both sample size and target study population for any statistical analysis.

The system can also include a template library of previous research methods, potential research methods, and ongoing research methods that can be matched by the system to a request for protocol development. The previous research methods, potential research methods, and ongoing research methods can be referenced in the questions presented to the user population. The response to those questions can be evaluated to determine a best approach with a high degree of confidence. In some embodiments, previous research methods, potential research methods, ongoing research methods, and/or publically available research methodologies can be stored as part of a template library. The template library can be accessed by the system to select element of any template, which can be combined into a complete research method. The system can be configured to present questions to the user population to identify templates and/or template elements for incorporation into a research methodology. In some embodiments, the system can be configured to automatically obtain information form electronic sources for inclusion in the template library. In addition, automatically obtained information can be subject to review prior to inclusion in the template library. In some examples, the system is configured to require review of a research or patient advocate prior to inclusion in the template library.

Example templates and template elements can include: drug/medical device/interventions schedule, modifications, precautions; device implantation procedures; dose modifications (which can also include one or any combination of: drug preparation information, drug administration information, drug storage information; drug/device accountability, retention, final disposition; required concomitant medications, if applicable; and treatment duration); information and/or evaluation of scientific need balanced against with subject burden; timeframe considerations including any consideration of time to collect data and accommodate enrollment; timeframe considerations including any limiting period to time necessary to insure collection of data to evaluate study endpoint; and definition of clinical endpoints (which can include one or any combination of: identifiable changes that shows the proposed intervention did what it was supposed to do; primary endpoint which measures the specific clinical effect the intervention is preventing/treating (e.g., patient survival, resolution of disease, etc.); and surrogate endpoints which measure changes in symptom/biological indicator for the success of the intervention (e.g., T-cell count, radiographic imaging, etc.)). Each template and/or template element can be categorized to reflect a type of study, a field of medicine, intended result, which the system can employ to match template and/or template elements to protocol development requests.

According to some embodiments, the system can be configured to evaluate any proposed protocol for ethics/human subject protection concerns as part of the determination of the study procedures. The system can be configured to evaluate any one or combination of: clinical study participant burden, appropriateness of including participants less than 18 years of age (if applicable) related to the expected risks and prospect of benefit. The questions delivered to user participants are configured to establish broad community agreement that identifies any ethical issues related to the proposed protocol.

The protocol builder system can be further configured to determine adverse experiences for any protocol challenge and/or request for protocol development. Examples of adverse experiences can include any one or combination of: safety; identified safety concerns; special safety concerns that an experimental intervention may raise; and identification of established safety profiles for medication(s) being tested.

According to some embodiments, the system can be further configured to generate clinical endpoints as part of the protocol development and/or evaluation. In some examples, clinical endpoints with clearly defined and measureable stopping points are defined. In some examples the endpoints can be defined based on interim and/or ongoing analysis of test results during test execution. Other endpoints can be defined by the user requesting protocol development. In some examples, a research or patient advocate can generate clinical endpoints and include them as requirements for the protocol. Further, the system can be configured to accept input from a review committee in generating, determining, and/or approving clinical endpoints. In some embodiments, the review committee can define clinical endpoints that must be followed for a given protocol. In addition, physician review can also be employed and any endpoint adhered to as part of the protocol. Example clinical endpoints can also establish criteria for terminating a trial if a clear benefit is shown, if a certain pre-determined proportion of adverse events occur, and/or if endpoints are not being met.

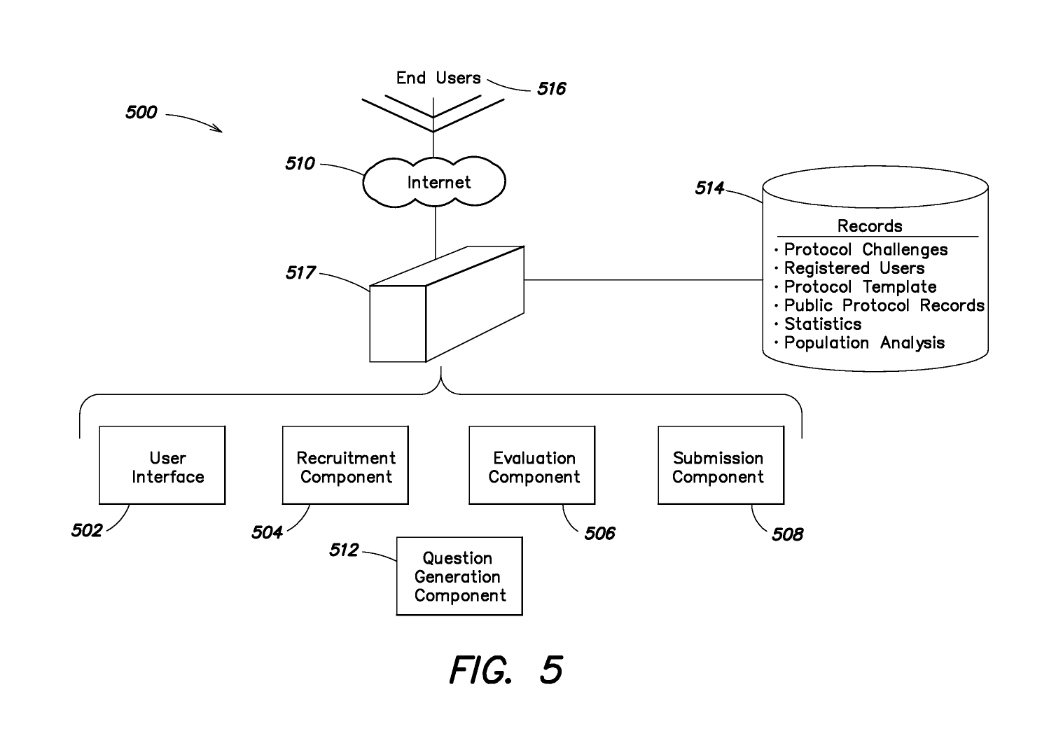

Various components of the protocol builder system can be configured to develop part or entire protocols. Shown in FIG. 5 is a block diagram of an example protocol builder system. The system can include a user interface accessible over a communication network (e.g., Internet 510). The system can also include a recruitment component 504 configured to identify and deliver invitations to potential users. Potential users can be matched to protocol challenges submitted to the system and target invitations delivered to the potential users to increase user feedback on given protocols. In some examples, a matching component can be configured to identify an expert in a particular field, a particular therapeutic area, medical practice area, among other options. Invitation can be targeted to the identified experts by the recruitment component based on information obtained from the matching component. In some embodiments, the matching component can be configured to poll the Internet to obtain matches to current protocol development projects. In other embodiments, the matching component can review information stored in a template library or other database to identify matching users.

Further matching can also be made against registered users and/or any information stored on registered users in the system database 514. The system can be configured to deliver notifications to registered users based on matches between information on the protocol development project. The notifications can include notices that protocol development projects are underway in that are in their field of interest, area of expertise, practice area, etc. In some embodiments, users can identify areas of interest and/or areas of expertise in which they wish to receive notifications. In some examples, user preferences can be stored as part of a user profile.

In some embodiments, user submissions can be evaluated by an evaluation component 506 which can be configured to assign scores and/or identify agreement on protocol development. The evaluation component can be further configured to present user submissions to a research or patient advocate who assigns scores to the user submissions. The user interface 502 can be configured to interact with a submission component 508, which permits submission of protocol development requests and submission of user ideas on protocol development. In one embodiment, the submission component can be configured to verify that user responses/submissions meet the requirements of a given protocol development request. The submission component can be further configured to prompt users for required information in a protocol development request. For example, the submission component can require information on a category to assign to the request, intended result of the protocol, a drug to evaluate, etc. The submission component can be configured to require definition of review criteria in a protocol development request, among other options.

In some embodiments, the submission component 508 can also be configured to accept user submissions regarding other user contributions submitted to the system. In particular, the submission component 508 can be configured to enable users to agree and/or disagree with contributions posted on the system by other users. Peer review of user contributions can then inform evaluations of the reviewed material, both by advocates and by automated processing performed by system.

System 500 can also include a challenge generation component 512, configured to access a template library stored on system 500. The storage for system 500 can include for example a database 514. Database 514 can be located on server 517 and store information on protocol challenges, protocol development requests, registered user information, invitation criteria, template libraries, protocol templates, public protocol records, statistics, population analysis, statistical models among other examples. The challenge generation component is configured to identify questions presented to end users 516 accessing the protocol builder system through, for example, respective host computer systems. The challenge generation component is configured to analyze submitted protocol development requests and identify existing protocol template and/or template elements that are applicable to the development request. The challenge generation component can be configured to present matching questions, templates, and/or template elements to a research or patient advocate for inclusion in the protocol development request. The challenge generation component can be configured to modify and/or update questions presented to users based on received responses. Further the challenge generation component can be configured to select from a population of questions for the protocol challenge based on information associated with a responding user. In some embodiments, the component can match information on profession, specialty, work experience, etc. to identify questions that the participating user is especially qualified to answer.

The various components of system 500 can be configured to operate together to perform processes for generating a drug trial protocol, for example, by executing the processes illustrated in FIGS. 2-3. The components of system 500 can be executed by a processor from memory to allow the system to provide for the operations and/or functions discussed above. In some embodiments, system 500 can include additional components. In one example, system 500 includes a natural language processor configured to parse user submissions. Based on the parsed submissions, the natural language processor (NLP) can assist in automated evaluation of user submissions. In some examples, the NLP can be configured to parse submissions and communicate the results to an evaluation component. The NLP can also be configured to capture information from publicly available sources including protocol publications made available by the FDA. Captured information from public sources can be matched against user submissions and/or drug protocol development projects, for example. The matched information can be incorporated by the system in developing questions for users. In some examples, matched information can be provided to a research or patient advocate for review prior to inclusion in any project.

The NLP can also be configured to process Internet based resources for matching drug protocol development projects against potential users. In one example, various publications can describe a given user's expertise in a field. A match between an ongoing drug protocol development project and user experience, for example, can be identified. The matched records can be made available to a recruitment component, for example 504, and an invitation delivered to any contact information extracted for the user.

Matching can be employed to identify matches on registered users, potential users, and drug protocol development project characteristics. In some setting, existing drug protocols and their clinical study protocol are available. Matching characteristics between existing clinical study protocols can yield information on study population, study design, etc. Any matching information can be incorporated into a drug protocol development process. Additionally, a research or patient advocate can curate the introduction of matching information into the protocol development process.

In some embodiments, a clinical study protocol can be collaboratively developed. Evaluation of the developed protocol can include a determination that the clinical study protocol meets or does not meet defined protocol endpoints during execution of the clinical study protocol. In some embodiments, an evaluation component is configured to track and evaluate the execution of a clinical study protocol. In particular, some embodiments of the system can accept input of data from an executing clinical study protocol. The input data can be evaluated by the evaluation component, e.g., 506. In some embodiments, a research or patient advocate is assigned to evaluate the input data and any results extrapolated from the data. The research or patient advocate can determine if defined endpoints have been met, will be met, or in some examples cannot be met. The determination on the endpoint can impact awards for participants. In some embodiments, awards can be contingent on meeting defined endpoints of a clinical study protocol, in others meeting the defined endpoints can be considered as a factor. Each drug protocol development can set different evaluation criteria.

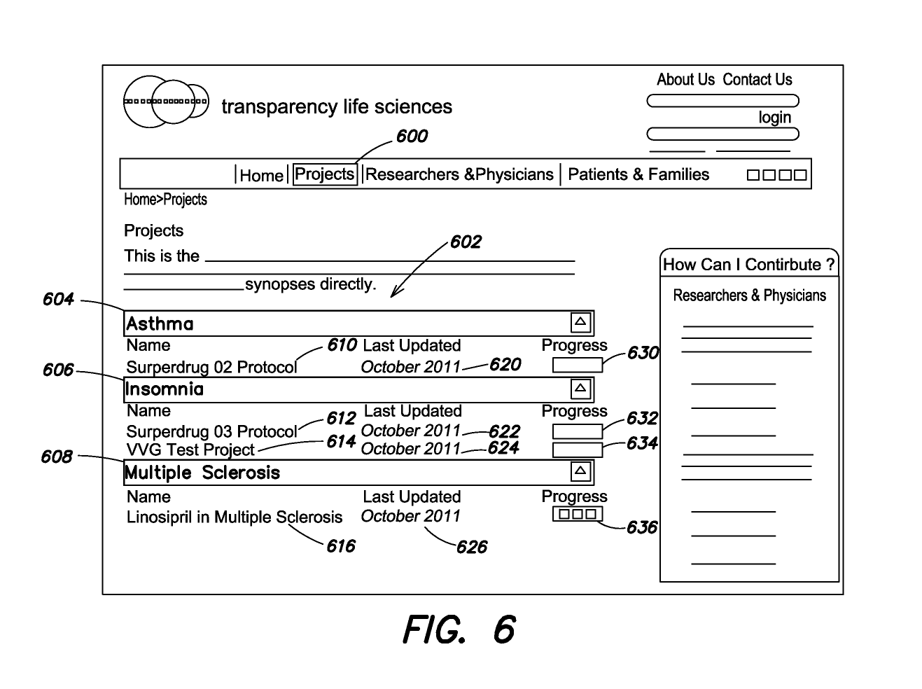

Shown in FIG. 6, is a screen capture of an example user interface. The user interface provides public access to a “Projects” page at 600. The projects page provides access to current protocol development projects. In some embodiments, inactive projects can also be shown. At 602 a frame of the user interface is displayed, which is configured to display active protocol development projects. The user interface is further configured to display the active projects based on category and/or field associated with the protocol development projects. Shown at 604-608 are examples of categories assigned to protocol projects. Examples categories include Asthma 604, Insomnia 606, and Multiple Sclerosis 608. Other categories can be supplied by a protocol builder system. The categories can be based on fields of medical specialization, for example, cardiology, urology, neurology, infectious diseases, among other. Categories can also include definition of a therapeutic area. Each project 610-616 is assigned a name that is displayed in the user interface. Additional information can be displayed with each project, including a last access date 620-626, and a progress indicator 630-636. Progress for a project can be determined automatically by the system, and in some embodiments, progress can be determined based on review by a research or patient advocate.

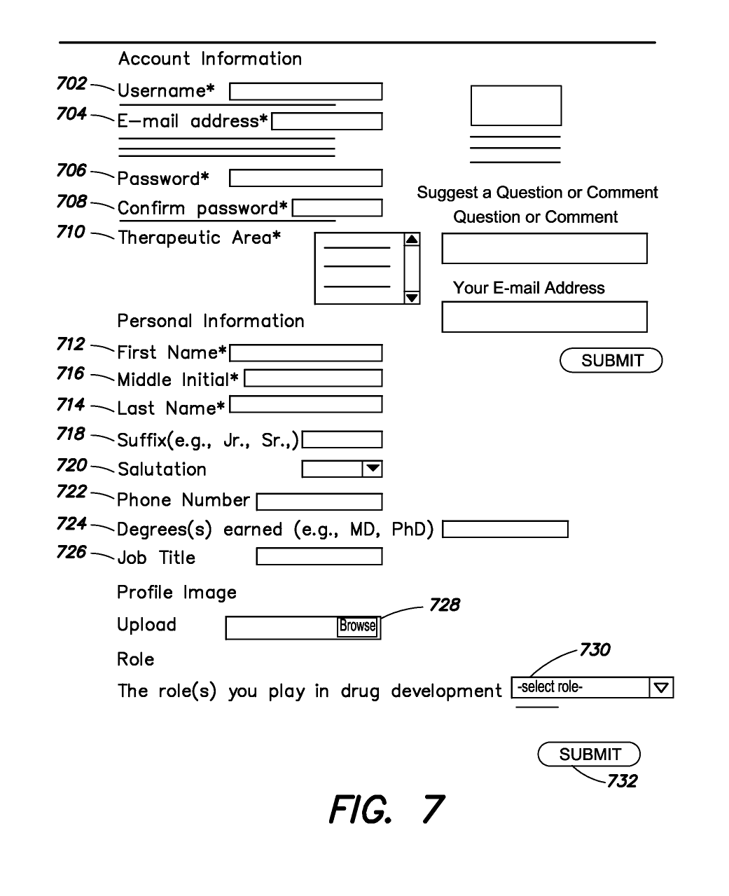

In some examples, access to individual projects 610-616 is restricted to registered users. In response to selection of any of the individual projects 610-616, the user interface is configured to bring the user to a registration screen. An example registration screen is shown in FIG. 7. The user interface is configured to require information for a registering user. For example, the user is asked to establish a user name at 702. Contact information is required at 704. The user wishing to register also specifies and confirms a password to associate with their account at 706-708. Background information can be requested in the user interface. In some examples, a therapeutic area may be required to proceed with registration. At 710, the user wishing to register can identify a therapeutic area that the user is, for example, experienced in or wishes to participate in.

Personal information can be required. In some embodiments, First Name 712 Last Name 714 can be required for registration. Additional information can be optionally input into the user interface, for example: middle initial 716, suffix 718, salutation 720, phone number 722, degrees(s) earned 724, and job title 726. The user interface can also be configured to upload an image 728 to associate with the user account. In some examples, the user wishing to register can identify a role that the user has performed in drug development at 730. Once the required information is input and any optional information is supplied, registration can continue by selecting submit at 732 in the user interface. In some embodiments, the user wishing to register is asked to review and agree to a “Terms of Use” for the site. In some embodiments, the user must agree to the terms in order to complete registration and participate in the protocol development process.

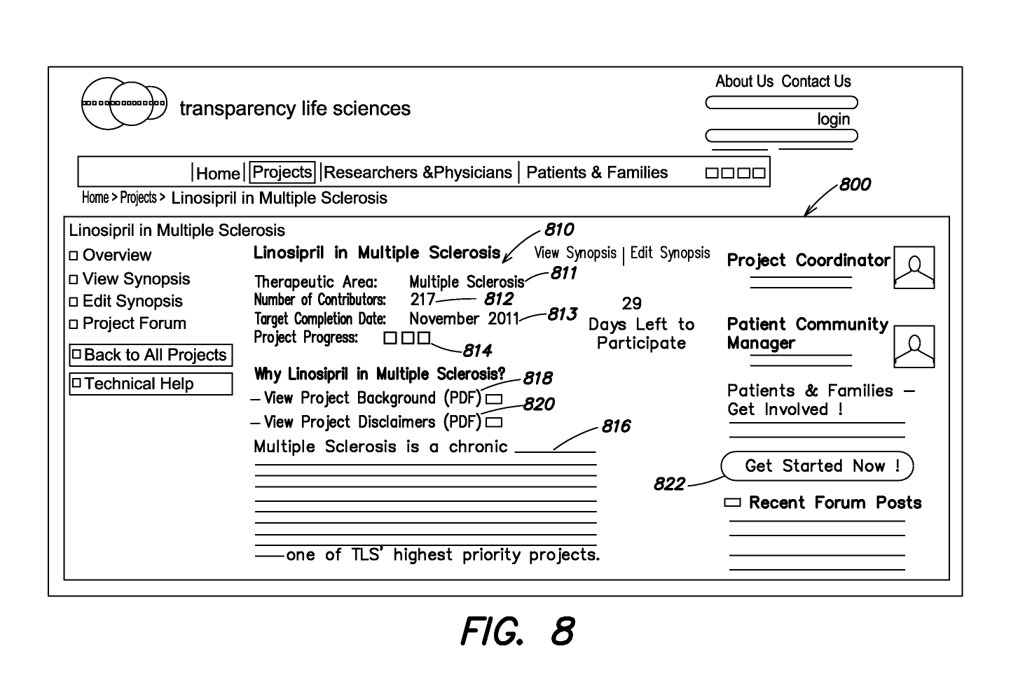

Registered users are permitted to access details associated with a given protocol development project. Various projects can have different targets, including for example, establishing a protocol to test a new drug, establish a protocol to improve drug testing, develop a protocol for a new therapeutic approach, and develop a protocol to improve a therapeutic approach. Shown in FIG. 8 is a screen capture of an example protocol development project detail screen 800. The project detail screen 800 includes information on the project and current state at 810. Project information can include Therapeutic Area at 811; Number of Contributors at 812; Target Completion Date at 813; and Project Progress at 814. A synopsis of the protocol development project is display at 816. Links to any documents associated with the project can be displayed in screen 800, for example, at 818 and 820. In some examples, links to additional terms and/or review criteria for the protocol development project can be provided as links to documents shown in screen 800.

According to some embodiments, the user interface is configured to display screen 800 to registered users accessing a protocol builder system over the Internet. The user interface can further be configured to permit registered users to participate in the protocol development project by selecting a hyperlink in the user interface. For example, “Get Started Now” at 822 in the user interface can be configured to allow users to being participating in challenges associated with the protocol project. In some embodiments, selection in the user interface of Get Started Now at 822 causes the user interface to transition to a set of challenges associated with the protocol development project. For a given protocol development project, multiple types of challenges can be available. In other examples, challenge questions can be displayed in the project detail screen directly.

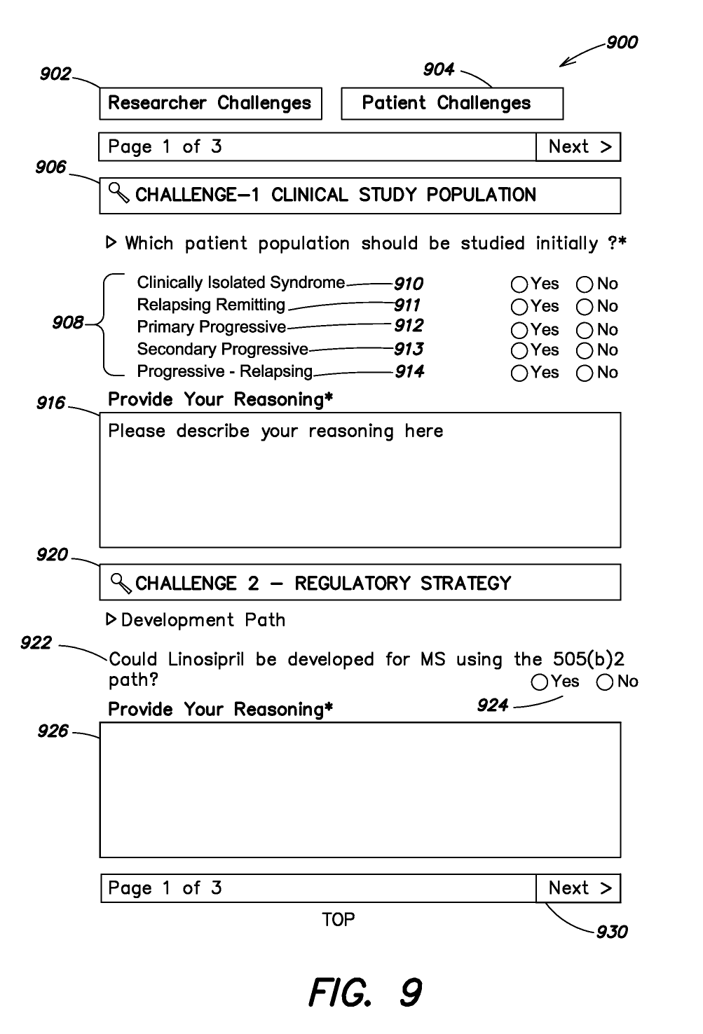

For example, shown in FIG. 9 is a screen capture of an example challenge screen 900 including challenge questions, which can be displayed as its own page, or can be displayed as part of a project detail screen. In some examples, screen 900 can be displayed as a portion of a protocol project detail screen 800. In some embodiments, screen 900 can be configured to display separately accessed by for example a hyperlink in a protocol project detail screen.

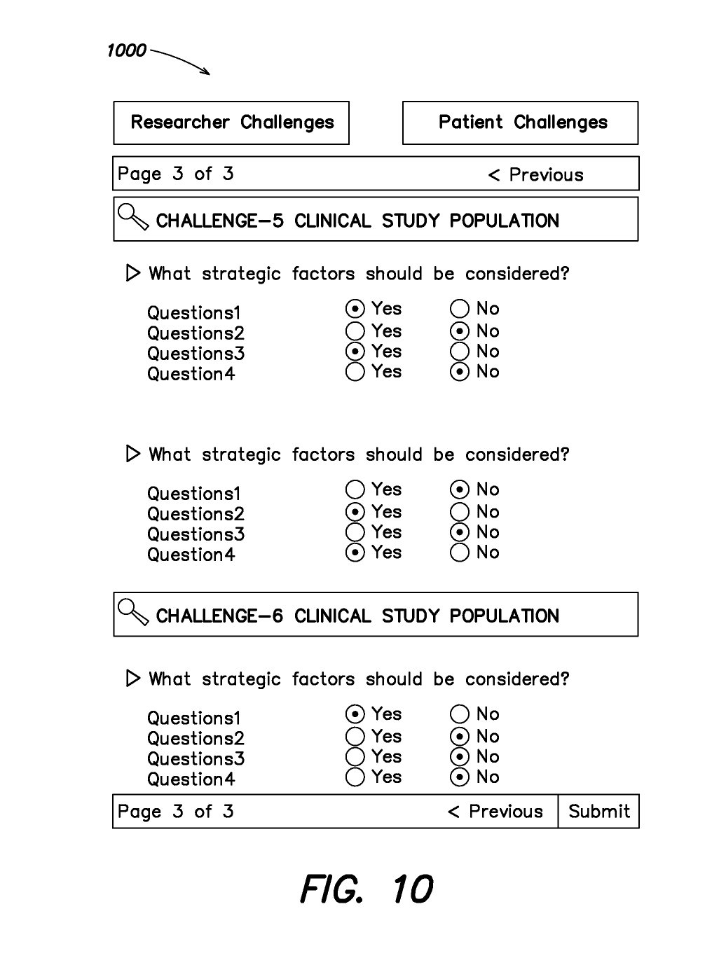

Challenge screen 900 includes tabs at 902 and 904 for separating the display of the two types of challenges available in the displayed protocol development project. Additional types and display tabs can be available in addition to tabs 902 and 904. Tab 902 is currently visualized in the display of screen 900. Selection of tab 904 causes the system to display the challenges of type “Patient Challenges.” Multiple pages of challenges (e.g., FIG. 10, page 1000) for each type can exist and be displayed in a user interface of a protocol builder system. The challenges presented can be organized based on topic, for example, clinical study population at 906. The challenges can also be organized based on steps of overall protocol development (as shown e.g., in FIG. 4 at 402-416). The user can be asked to answer questions associated with a topic before proceeding to additional question on another topic of protocol development. For patient population, the challenge questions can be configured to elicit the best patient population for a given phase of a protocol development plan.

In some embodiments, possible answers to challenge questions can be presented to the user for selection on a YES/NO basis at 908. Further, multiple selections can be input in the user interface in response to challenge questions, including for example, multiple choice selections (not shown). In some examples, a third option can include “never” to indicate that a particular patient population would not be appropriate for a particular drug protocol development project. Such answers can be tracked, and optionally reviewed for soundness. The tracked answers can be used for future drug protocol development projects to include and/or exclude candidate patient populations from challenge questions.

At 908, the user interface displays a series of candidate patient populations. Candidate populations can be identified during creation of a drug protocol development project. In some examples, a user can submit a request for a drug protocol development project which includes user identified patient populations. In addition, a submission component can be configured to match information submitted in the request for a drug protocol development project or other information available on a protocol builder system to existing protocols having identified patient populations. Based on matches between the information submitted and existing protocols, the system can automatically present the identified patient populations as candidate patient populations. The system can be configured to automatically identify some or all of the patient populations. In some embodiments, the system can be configured to augment user supplied patient populations.

In some embodiments, the protocol builder system can be configured to present the identified and/or submitted patient populations to a research or patient advocate for review. The system can be configured to require approval of a research or patient advocate prior to presenting candidate populations as challenge questions. In some embodiments, a submission component can be accessed by a user external to the system for inputting a drug protocol development project. In addition, the submission component can also be accessed by administrative users (e.g., system administrators, research advocates, patient advocates, review committees, etc.) who can also input drug protocol development requests. In some settings, protocol development requests are submitted to administrative users, reviewed, and then made available to the registered users of the protocol builder system.

Once candidate patient populations are identified and optionally approved, the candidate patient populations are presented within challenge questions, for example, shown on page 900 at 908. Example patient populations include clinically isolated syndrome 910; relapsing remitting 911; primary progressive 912; secondary progressive 913; and progressive—relapsing 914. In some embodiments, additional patient populations are presented. Further, already executed drug trials can include additional patient population definitions that have been explored in a clinical trial setting, each of these populations is made available for matching by the system, and any of the additional patient populations can be included. In some examples, additional patient populations can be evaluated by presenting each as a challenge questions. In addition to executed trials as a source of patient populations, literature on patient population definition can also be presented, and challenge questions formulated to target patient populations definitions presented in available literature.

In some embodiments, the system can be configured to poll existing literature for protocol development ideas and concepts, including any ideas and concepts specific to drug protocol development. Any matching literature can be stored on the system, and used in subsequent review by, for example, the submission component, to identify candidate patient populations. Protocol development literature can be readily identified using the Internet and known search algorithms, and/or known search engines. The protocol builder system can be configured to automatically retrieve and store protocol development literature and/or information on executed trials from publically accessible sources. In some embodiments, the system can be configured to automatically execute searches for protocol development literature and/or information on executed trials. In some embodiments, a matching component can identify search criteria based on information associated with input protocol development requests and/or current protocol development projects.

The protocol builder system can be further configured to identify categories of interest for any trial or literature, based on, for example, therapeutic area, medical practice area, defined patient populations, clinical goals, and/or application drug protocol milestones (e.g., as illustrated in FIG. 4). In some embodiments, each identified category of interest can be stored and used for matching against protocol development projects. In one example, the stored literature and/or executed trial literature can be parsed to identify information of interest and the parsed information used in matching against protocol development projects.

In addition to trial information and literature obtained by the system, the registered users can also suggest additional patient populations and/or provide their reasoning for selecting/rejecting specific patient populations in 916. The answers provided to the challenge question, as well as the reasoning provided can be evaluated in determining a score for a user's contribution to the development project. Each challenge can be scored separately. In some embodiments, points can be awarded based on scoring of the user's contribution. In some examples, points can be accumulated to redeem awards. In other examples, points can be exchanged for good and/or services. In some embodiments, points can be awarded based on review by a research or patient advocate, automated review by an evaluation component, and in others by a combination of research or patient advocate and automated review. The review criteria that the system employs can be presented in a protocol project detail screen, e.g., 800 via link 820. In some embodiments, the system can be configured to require agreement to any additional terms associated with a specific project prior to allowing a user to submit responses to challenge questions.

Multiple challenges can be organized into multiple topics (e.g., 906 and 920) each having challenge questions. At 920, a second challenge topic is display in the user interface regarding regulatory strategy for the protocol development project. At 922 the user interface displays the challenge question “Could lisinopril be developed for MS using the 505(b)2 path?” At 924 the user is prompted for a yes no response. Other development paths can be displayed. Further, the user's reasoning for the response is requested at 926. As discussed above, a user requesting a protocol development project can input candidate paths for challenge questions, additionally the protocol builder system can be configured to automatically identify candidate paths. In some embodiments, all identified paths (e.g., by the user, by the system) are reviewed and approved before being incorporated into challenge questions. Information on executed trials can be stored on the system, and matches between previously executed trials and information for a current protocol development project used to identify candidate paths. Additionally, protocol development literature describing development paths can be matched to information in a protocol development project, and any described development path(s) automatically suggested by the system for inclusion in a protocol development project.

In addition, registered users can suggest additional candidate development paths via the user interface, e.g., at 926. According to some embodiments, research or patient advocates review challenge answers and any reasoning submitted during the course of a protocol development project. Additional candidate paths can be identified and challenge questions modified or augmented to include new candidate development paths based on submitted comments.

At 930, a button configured to provide access to additional challenge topics and/or questions is displayed. In response to user selection, button 930 caused the system to display any additional pages of challenge topics and associated questions (e.g., FIG. 10 page 1000).

Additional challenge topics and questions can be accessed from screen 900, in response to selection of 904 in the user interface. The protocol builder system is configured to solicit and process input from drug developer experts as well as patients. Patients can contribute their knowledge of clinical procedures to the protocol development project. Patient challenges can be presented in the user interface organize by topic, for example, as displayed at 908. Multiple challenge topics can be presented to users who wish to participate in patient challenges. In some embodiments, users can identify therapeutic areas in which they have experience or wish to participate in during registration. Additionally, user can identify that they wish to participate in patient challenge development. In some settings, user's can participate as either patient participants or research participants with different challenges being presented to the different user populations based on their registration selection. In some embodiments, users can participate in either category of challenge, and can transition between research directed challenges and patient directed challenges by selecting portions of the user interface.

Various embodiments according to the present invention may be implemented on one or more specially programmed computer systems, including for example FIG. 5 protocol builder system 500. These computer systems may be, for example, general-purpose computers such as those based on Intel PENTIUM-type processor, Motorola PowerPC, AMD Athlon or Turion, Sun UltraSPARC, Hewlett-Packard PA-RISC processors, or any other type of processor, including multi-core processors. It should be appreciated that one or more of any type computer system may be used to facilitate hosting a curated environment for open development of clinical trial studies and in particular clinical trial studies for drug testing according to various embodiments of the invention. Further, the system may be located on a single computer or may be distributed among a plurality of computers attached by a communications network.

A general-purpose computer system according to one embodiment of the invention is specially configured to perform any of the described functions, including but not limited to, creating, storing, parsing, matching, evaluating, and displaying protocol development projects, project details, and challenge questions and/or answers associated with a protocol development project, etc., and the invention is not limited to having any particular function or set of functions.

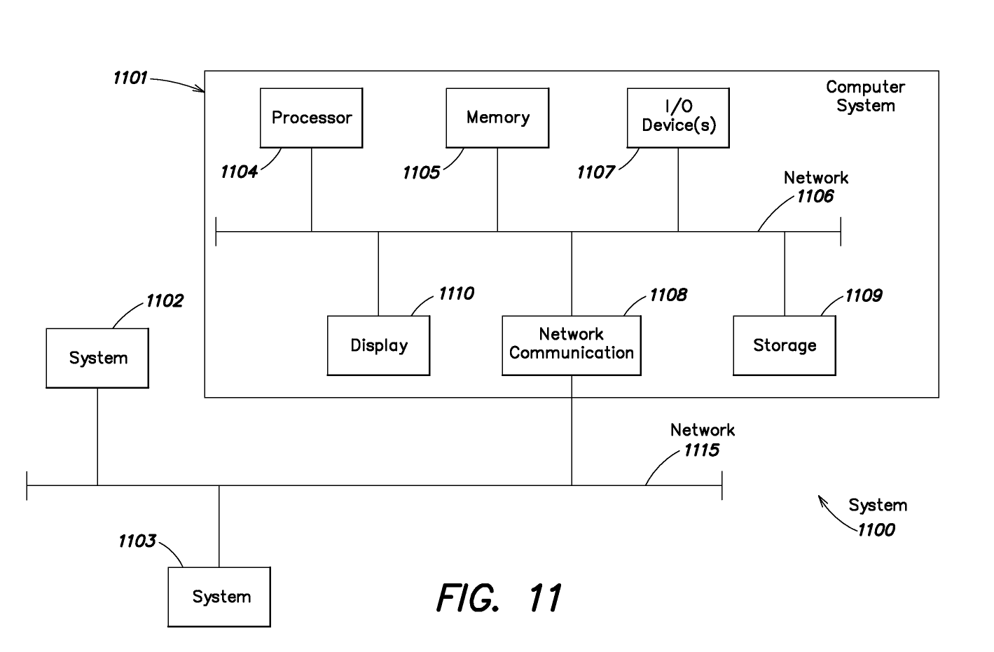

FIG. 11 shows a block diagram of a general purpose computer and network system 1100 in which various aspects of the present invention may be practiced. For example, various aspects of the invention may be implemented as specialized software executing in one or more computer systems including general-purpose computer systems 1101-1103, shown in FIG. 11. The computer systems 1101-1103 may include a processor 1104 connected to one or more memory devices 1105, such as a disk drive, memory, or other device for storing data. Memory 1105 is typically used for storing programs and data during operation of the computer system. Components of computer system may be coupled by an interconnection mechanism such as network 1106, which may include one or more busses (e.g., between components that are integrated within a same machine) and/or a network (e.g., between components that reside on separate discrete machines). The interconnection mechanism enables communications (e.g., data, instructions) to be exchanged between system components of the system 1101.

Computer system also includes one or more input/output (I/O) devices 1107, for example, a keyboard, mouse, trackball, microphone, touch screen, a printing device, display screen, speaker, etc. Multiple displays can be included in computer system 1101, e.g., display 1110. Display 1110 can be a separate device, and integrated display, and can be configured to display in a plurality of display formats. In addition, computer system may contain one or more interfaces (e.g., network communication device 1108) that connect computer system to a communication network 1115 (in addition or as an alternative to the network 1106).

The storage system 1109, typically includes a computer readable and writeable nonvolatile recording medium in which signals are stored that define a program to be executed by the processor or information stored on or in the medium to be processed by the program. The medium may, for example, be a disk or flash memory. Typically, in operation, the processor causes data to be read from the nonvolatile recording medium into another memory that allows for faster access to the information by the processor than does the medium. This memory is typically a volatile, random access memory such as a dynamic random access memory (DRAM) or static memory (SRAM). The memory may be located in storage system, as shown, or in memory system. The processor generally manipulates the data within the memory 1105, and then copies the data to the medium associated with storage after processing is completed. A variety of mechanisms are known for managing data movement between the medium and integrated circuit memory element and the invention is not limited thereto. The invention is not limited to a particular memory system or storage system.

The computer system may include specially-programmed, special-purpose hardware, for example, an application-specific integrated circuit (ASIC). Aspects of the invention may be implemented in software, hardware or firmware, or any combination thereof. Further, such methods, acts, systems, system elements and components thereof may be implemented as part of the computer system described above or as an independent component.

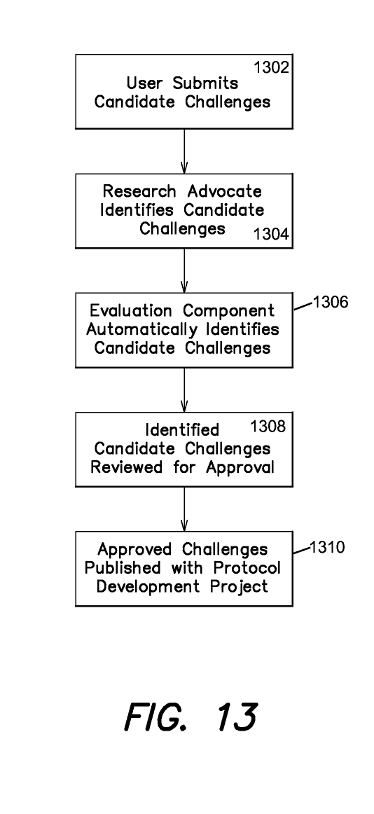

Although the computer system of FIG. 11 is shown by way of example as one type of computer system upon which various aspects of the invention may be practiced, it should be appreciated that aspects of the invention are not limited to being implemented on the computer system as shown. Various aspects of the invention may be practiced on one or more computers having a different architectures or components that that shown in FIG. 11. The system 1100 can execute the process illustrated in FIG. 13, and/or components of a system (e.g., system 500) can be configured to execute the process illustrated in FIG. 13.

In FIG. 13, the example process begins at 1302 with user submission of candidate challenges. In some embodiments, in addition to user submission, research or patient advocates can also identify candidate challenges at 1304. In other embodiments, an evaluation component can be configured to automatically identify candidate challenges at 1306. In some implementation, one or more sources can be used to identify candidate challenges (i.e., one or more of 1302, 1304, and 1306). At 1308 any identified challenges are reviewed for approval. At 1310 the approved challenges are published with a protocol development project.

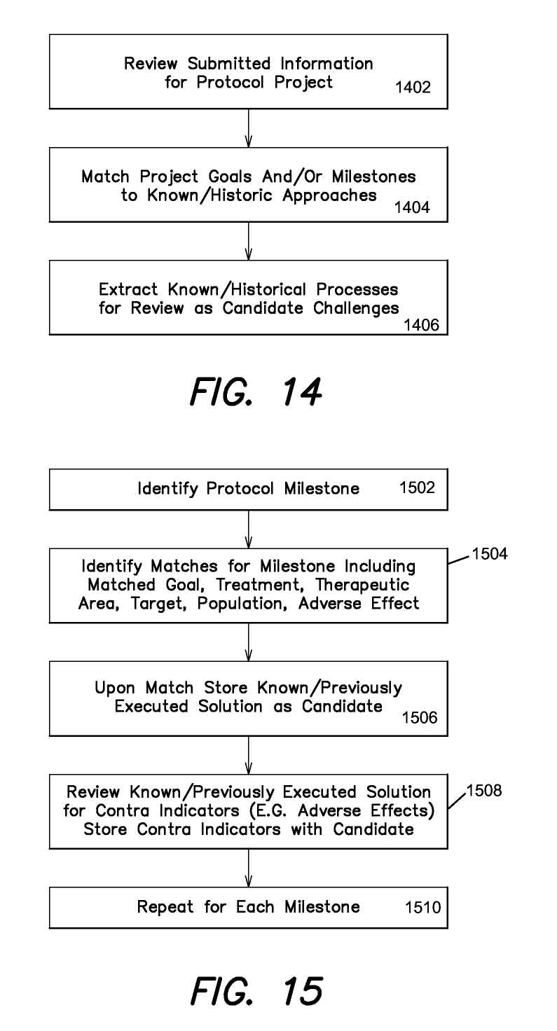

The process executed on such systems can include also other processes, for example, illustrated in FIGS. 14-15. FIG. 14 illustrates an example process for matching protocol projects to known and/or existing clinical protocols. The matched approaches can then be presented as candidates for review. As shown, the process begins at 1402 with review of information submitted for a protocol project. The information can be matched (e.g., 1404) to known approaches, and information from known approached can be extracted at 1406 based on any matches. FIG. 15 illustrates a pseudo code process for matching protocol information to known/existing approaches to generate candidate challenges for review. FIG. 15 also illustrates extracting contra indicators that can reflect disadvantages to using a given candidate as a protocol challenge. The process begins at 1502 with identification of protocol milestones. Information for the milestone can be matched against known approaches at 1504. Any matched can be used to capture and store known solutions at 1506, and/or known approaches associated with specific milestones. The approaches can also be captured with any additional information (e.g., indicating success or failure, among other options). At 1508 any matches on known/previously executed approaches can be reviewed to establish any contra indicators. At 1510, the analysis can be repeated for each milestone in a given protocol. As discussed, the processes shown in FIGS. 14-15 can be executed on general purposed computer systems.

The computer system may be a general-purpose computer system that is programmable using a high-level computer programming language. The computer system may be also implemented using specially programmed, special purpose hardware. In the computer system, processor is typically a commercially available processor such as the well-known Pentium class processor available from the Intel Corporation. Many other processors are available including multi-core processors and microprocessors. Such a processor usually executes an operating system which may be, for example, the Windows-based operating systems (e.g., Windows NT, Windows 2000 (Windows ME), Windows XP, Windows VISTA, Windows 7 operating systems) available from the Microsoft Corporation, MAC OS System X operating system available from Apple Computer, one or more of the Linux-based operating system distributions (e.g., the Enterprise Linux operating system available from Red Hat Inc.), the Solaris operating system available from Sun Microsystems, or UNIX operating systems available from various sources. Many other operating systems may be used, and the invention is not limited to any particular operating system.

The processor and operating system together define a computer platform for which application programs in high-level programming languages are written. It should be understood that the invention is not limited to a particular computer system platform, processor, operating system, or network. Also, it should be apparent to those skilled in the art that the present invention is not limited to a specific programming language or computer system. Further, it should be appreciated that other appropriate programming languages and other appropriate computer systems could also be used.

One or more portions of the computer system may be distributed across one or more computer systems coupled to a communications network. These computer systems also may be general-purpose computer systems. For example, various aspects of the invention may be distributed among one or more computer systems (e.g., servers) configured to provide a service to one or more client computers, or to perform an overall task as part of a distributed system. For example, various aspects of the invention may be performed on a client-server or multi-tier system that includes components distributed among one or more server systems that perform various functions according to various embodiments of the invention including displaying, accessing, evaluating drug protocol development projects, as examples. Other components can be configured to execute recruitment functions, poll electronic resources for protocol development literature and/or executed drug trials, parse electronic resources for matching to current drug protocol development projects, etc. These components may be executable, intermediate (e.g., IL) or interpreted (e.g., Java) code which communicate over a communication network (e.g., the Internet) using a communication protocol (e.g., TCP/IP).

It should be appreciated that the invention is not limited to executing on any particular system or group of systems. Also, it should be appreciated that the invention is not limited to any particular distributed architecture, network, or communication protocol.

Various embodiments of the present invention may be programmed using an object-oriented programming language, such as Java, AJAX, C++, Ada, or C# (C-Sharp). Other object-oriented programming languages, such as Ruby on Rails, Python, may also be used. Alternatively, functional, scripting, and/or logical programming languages may be used. Various aspects of the invention may be implemented in a non-programmed environment (e.g., documents created in HTML, XML, PHP, CSS or other format that, when viewed in a window of a browser program, render aspects of a graphical-user interface (GUI) or perform other functions). Various aspects of the invention may be implemented as programmed or non-programmed elements, or any combination thereof.

Various aspects of this system can be implemented by one or more systems within the computer system. For instance, the system may be a distributed system (e.g., client server, multi-tier system). In one example, the system includes software processes executing on a system associated with a user (e.g., a client system). These systems may permit the user to register, answer challenge questions, submit free form opinion information, request a drug protocol development project, review user submission, evaluate user submission, etc. Further, client systems can be associated with registered users who access, for example, a curated environment for open development of clinical trials.

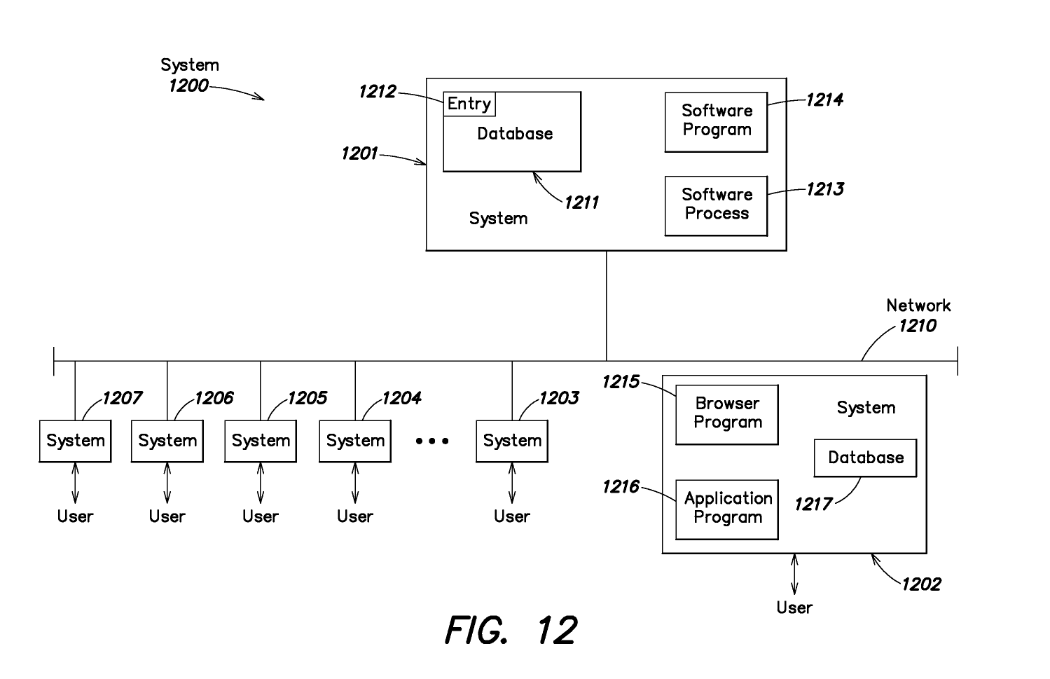

FIG. 12 shows an architecture diagram of an example system according to one embodiment of the invention. It should be appreciated that FIG. 12 is used for illustration purposes only, and that other architectures may be used to facilitate one or more aspects of the present invention.

As shown in FIG. 12, a distributed system 1200 can include a plurality of general purpose computer system (e.g., 1201-1207) specially configured to conduct functions of a protocol builder system, including, but limited to, generation, monitoring, and evaluation of challenge questions, recruitment, information polling for protocol development information, automatic matching, automatic submission evaluation, etc. The distributed system 1200 may include one or more general purposed computer systems (e.g., 1201-1207) coupled by a communication network 1210. Such computer systems may be, for example, general-purpose computer systems as discussed above with reference to FIG. 11.

In one embodiment of the present invention, a system 1201 stores attributes associated with drug protocol development projects, collected information on protocol development, and collected registration information for users on one or more databases 1211. Each drug protocol development project can be associated with an entry 1212 in the database, although other database models can be used. In some examples, a relational database model is implemented, and in others, non-relational database models can be employed.

Further, the system 1201 performs associated functions with the displaying, classifying and evaluating of challenge question submissions, among other operations. The system 1201 can also be configured to provide access to information associated with current drug protocol development projects, completed projects, polled protocol development information, matching users, matching protocols, and can be configured to display any information through a user interface accessible over a communication network 1210, for example, the Internet.

The system 1201 may include a server process 1213 that responds to requests from one or more client programs. Process 1213 may include, for example, an HTTP server or other server-based process (e.g., a database server process, XML server, peer-to-peer process) that interfaces to one or more client programs distributed among one or more client systems, for example 1202-1207, to provide access to information on protocol development projects.

According to one embodiment, client programs may be capable of permitting a user to create, submit, alter, monitor, and comment on challenge questions and protocol development projects within an online user interface. Such client programs may include, for example, any type of operating system and/or application program capable of communicating with the system through a network. In one particular instance, a client may include a browser program (e.g., browser program) that communicates with server process using one or more communication protocols (e.g., HTTP over a TCP/IP-based network, XML requests using HTTP through an Ajax client process, distributed objects, https, or other secure or non-secure communication protocol).

Although it is shown by way of example that a browser program (e.g. 1215) may be used to access a protocol builder system by users to perform functions for developing drug protocols, it should be appreciated that other program types may be used to interface a user to server process 1213 or a protocol builder system. For instance, an application program 1214 that is specially-developed to manage drug protocol development may be provided to permit a user to participate in a project, answer challenge questions, etc., according to various embodiments of the present invention. A client program may be, for example, a thin client including an interface for submitting and monitoring challenge questions, and/or drug protocol development projects. Alternatively, the client may be a scripted program, or any other type of program having the capability of transferring data. According to one embodiment, such client programs may, for example, be downloaded and installed over the network. Further, these client programs may be stored and distributed by system in the form of one or more software programs, including for example, browser plug-ins, active x objects, applets, and java code. Clients programs can also include executable programs downloaded and installed onto a host computer (e.g. mobile phone, tablet, laptop, desktop, etc.). In some embodiments, the client programs can be configured to deliver tele-medicine operations, including for example, patient diagnosis and/or patient diagnostics. In one embodiment, the client program is configured to transmit medical, imaging, and/or heath informatics data from a host computer to a protocol builder system.

In some examples, a mobile device can download and install an executable program. The executable program can be configured to receive user input regarding ongoing study protocols. In one example, the executable program can be configured to track data regarding defined end-points for a study protocol. The data can include preliminary results in a clinical setting, patient responses to a treatment, etc. The collected data can be reviewed by the protocol builder system to validate a protocol, and/or can also be used to determine awards to participating users. In some embodiments, the executable program can also be configured to notify an end user of updates to a given protocol development project.

In one example, the client program may include an application program 1216 that permits submission of challenge response, user registration, and monitoring of protocol development. This program, in one embodiment, may be integrated with browser program 1215 executing on, for example, system 1202. For instance, the application program may include one or more controls that, when selected by the user, perform functions for manipulating submitted challenge responses. These controls may be written in a variety of programming languages, and the invention is not limited to any particular language. In one specific example, the control may be a link that, when selected, performs one or more programmed functions. Such functions may permit the user to create, submit, view, monitor, register and alter challenge submissions to the protocol builder system.

Information can be stored locally on the database 1217 and may include, for example, real-time project development information, user entered submissions, notification messages, user profile information, current protocol development projects, completed protocol development projects, awards earned, pending awards, and other information that can be used to facilitate the development of clinical study protocols.

This information may be collected from the user in an interface (e.g., as presented by program 1216) and stored in the database (e.g., database 1217). Additionally, client systems 1202-1207 may store a local copy of a user's information and any pending submission within a local database associated with the client system (e.g., database 1217 located on client system 1202). However, it should be appreciated that the invention is not limited to storing information in any particular location. A client system (e.g., clients 1202-1207) may include one or more interfaces through which protocol development information may be presented to the user. In one example, protocol information and status may be presented in an interface of a browser program (e.g., browser program 1215) executing on a client computer system (e.g., system 1202).

Having thus described several aspects of at least one embodiment, it is to be appreciated various alterations, modifications, and improvements will readily occur to those skilled in the art. Such alterations, modifications, and improvements are intended to be part of this disclosure and are intended to be within the scope of the invention. Accordingly, the foregoing description and drawings are by way of example only.

1. A system for open clinical study protocol development, the system comprising:
at least one processor operatively connected to a memory, the at least one processor when executing provides:
a user interface configured to register a plurality of users for access to a curated environment, wherein the user interface is further configured to provide access to protocol development projects;
a challenge generation component configured to identify candidate challenges for protocol development, wherein each candidate challenge is configured to define at least one aspect of a clinical trial for a drug;
an evaluation component configured to present candidate challenges for acceptance, wherein the evaluation component is further configured to receive approval for at least some of the candidate challenges;
wherein the user interface is further configured to accept a plurality of submissions from a plurality of registered users in response to the approved challenges; and
wherein the evaluation component is further configured to present the plurality of submissions for review by a review advocate.

2. The system according to claim 1, further comprising a matching component configured to match information in a protocol development project against existing clinical protocol approaches.

3. The system according to claim 2, wherein the challenge generation component is configured to identify at least one candidate challenge for protocol development, responsive to the match by the matching component.

4. The system according to claim 1, further comprising a matching component is further configured to match a research or patient advocate to a protocol development project.

5. The system according to claim 1, wherein the evaluation component is configured to present the candidate challenges to the research or patient advocate for approval.

6. The system according to claim 5, wherein the evaluation component is further configured to receive scores for each of the plurality of submission from the research or patient advocate.

7. The system according to claim 1, further comprising a communication component configured to deliver the plurality of submissions to each one of the plurality of registered users who submitted a response.

8. The system according to claim 7, wherein the communication component is configured to provide access to protocol development projects and the plurality of submissions to any registered user.

9. The system according to claim 7, wherein the communication component is configured to query publically available information on known protocol development approaches and define a template library of information associated with the known protocol development approaches.

10. The system according to claim 1, wherein the evaluation component is configured to determine procedural and safety issues for at least one protocol development project.

11. The system according to claim 1, wherein the evaluation component is configured to generate verifiable targets for inclusion in at least one protocol development project.

12. The system according to claim 1, wherein the challenge generation component is configured to define survey questions for at least one candidate challenge that define the at least one aspect of the clinical trial for the drug.

13. The system according to claim 1, wherein the challenge generation component is configured to tailor survey questions to target at least one of: ideas from related publications, examples from similar projects, previously executed studies, and study population characteristics.

14. A computer implemented method for clinical study protocol development, the method comprising:
providing access to a user interface accessible over a communication network;
displaying in the user interface a plurality of protocol development projects;
accepting, by a computer system, a plurality of user submissions responsive to displayed challenges representing certain design elements associated with the protocol development projects;
accepting, by the computer system, evaluations of the plurality of user submissions determined by a research or patient advocate; and
establishing, by the computer system, at least one element of a clinical study protocol based on the evaluations of the plurality of user submissions.

15. The method according to claim 14, further comprising an act of presenting the evaluations of the plurality of user submissions to a plurality of users, wherein the plurality of users input respective submissions for a respective protocol development project.

16. The method according to claim 14, further comprising an act of identifying, by the computer system, candidate challenges for protocol development, wherein each candidate challenge is configured to define at least one aspect of a clinical trial for a drug.

17. The method according to claim 16, wherein the act of identifying includes an act of generating, by the computer system, at least one candidate challenge for protocol development, in response to matching at least one of the plurality of protocol development projects to an existing clinical protocol.

18. The method according to claim 16, further comprising an act of presenting in a user interface candidate challenges for acceptance.

19. The method according to claim 14, further comprising an act of identifying potential users based on matches determined between information associated with a protocol development project and demographic information of the potential users.

20. The method according to claim 19, further comprising an act of inviting the potential users to participate in the protocol development project.

21. The method according to claim 14, further comprising displaying the plurality of user submissions to registered users.

22. The method according to claim 14, further comprising an act of querying publically available information on known protocol development to define a template library of information associated with the known protocol development approaches.

23. The method according to claim 14, further comprising an act of determining, by the computer system, procedural and safety issues for at least one protocol development project.

24. The method according to claim 14, further comprising an act of generating, by the computer system, verifiable targets for inclusion in the at least one protocol development project.

25. The method according to claim 14, further comprising an act of generating, by the computer system, survey questions for at least one of the displayed challenges, wherein the response are configured to define the at least one element of a clinical study protocol.

26. The method according to claim 25, wherein the act of generating includes tailoring survey questions to target at least one of: ideas from related publications, examples from similar projects, previously executed studies, and study population characteristics.

27. The method according to claim 14, wherein the plurality of user submissions include at least one of protocol challenges and responsive submissions.
